(19) United States
(12) Patent Application Publication
(10) Pub. No.: US 2002/0003899 A1
(43) Pub. Date: Jan. 10, 2002

(54) Method for determination of input data in sheet handling apparatus

(76) Inventor: Kazumi Nagata, Tokyo (JP)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/900,076

(22) Filed: Jul. 6, 2001

(30) Foreign Application Priority Data
Jul. 7, 2000 (JP) 2000-206599

(51) Int. Cl. G06K 9/00; G06K 9/32; G06K 7/10; G06K 5/04

(52) U.S. Cl. 382/187; 235/462.08

(57) ABSTRACT

A system and method are described to accurately determine input data provided in a plurality of different formats, for example, on different areas of a statement. Where a bar code with check digits is present the sum is displayed, and a confirm key used to confirm the accuracy of the input data. If bar codes with check digits are not present or are not read normally, but an OCR sum area with check digits is present, then this data will be used. If an OCR sum area with check digits is not present (or are not read normally) but a handwritten area is present and normally read, that data will be used, again subject to a confirmation.

### BACKGROUND OF THE INVENTION

The present invention relates to an input data fixing method in a sheet handling apparatus capable of handling various statements, for example, for tax payments or transfers, in automated-teller machines, and more particularly, to an input data fixing method for reading and fixing data of the same kind, as provided for payment of a statement. The sheet handling apparatus of a preferred embodiment includes apparatus such as an automated-teller machine (ATM).

In sheet handling apparatus of the related art, such as a conventional ATM, the input data, for example, the requested cash or the date are fixed by one input device or specification. In the case of optical character reading (OCR), the input data are fixed exclusively by the OCR input. In the case of a keypad, the input data from ten keys provide the data. Where there is handled a statement in which data are provided in a plurality of different formats, including bar code, OCR characters, and handwritten characters, therefore, much of the data not used.

As has been described above, the prior art has a problem that data provided in different formats does not contribute to improved reliability or improved interpretation of the input data. Where there is handled a statement in which identical data are provided in a plurality of different formats, including bar code (high precision in interpretation), OCR printed characters (intermediate precision) and handwritten characters (low precision), for example, the bar codes are not utilized, if the system is to interpret the input data based on OCR technology. Similarly, if the sheet handling apparatus is to accept the input data by the key input signals, the bar codes or the OCR characters, if printed on the statement, are not utilized. In addition, this means that more time is required to input the data, and there is a greater chance of error.

One goal of the present invention is to eliminate the above-specified problems and to provide an input data acceptance technology in a sheet handling apparatus, which can receive the data in a plurality of different formats reliably.

### SUMMARY OF THE INVENTION

To provide such a system, according to the present invention, data, as provided in a plurality of formats, such as bar codes with check digits, OCR characters with check digits, or handwritten characters are read, and the data to be used is determined from the input data by a suitable algorithm. For example, if the data as so interpreted includes conflicting information, the data may be interpreted based on the majority of the input signals.

Alternatively, the plurality of formats can be given priorities in advance, and from the normally read data, the data provided by the highest priority source chosen as the data to be adopted. If the data to be adopted consists of handwritten characters, they are collated to data provided by keyboard to improve reliability.

### BRIEF DESCRIPTION OF THE DRAWINGS

FIG. 1 is a schematic view of an ATM according to a preferred embodiment;

FIG. 2 is a block diagram of the ATM according to a preferred embodiment;

FIG. 3 is a diagram showing one example of the priorities of different formats;

FIG. 4 is a flow chart for explaining one example of a processing procedure for determining a sum from image data read from a statement;

FIG. 5 is a diagram showing one example of the format of a statement employed in a preferred embodiment;

FIG. 6(a) is a diagram showing input screens displayed on a display unit of a sheet handling apparatus; and

FIG. 6(b) is a diagram showing one example of an input screen.

### DESCRIPTION OF THE SPECIFIC EMBODIMENTS

With reference to the accompanying drawings, there is next described in detail an embodiment in which a sheet handling apparatus according to the present invention is applied to an automated-teller machine (ATM).

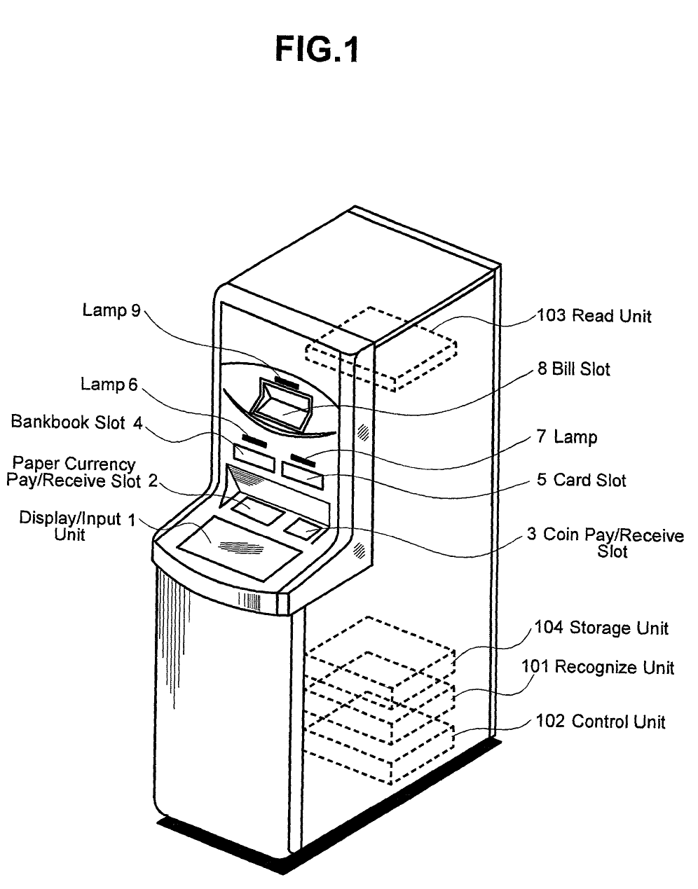

FIG. 1 is a schematic view of an ATM in a preferred embodiment. In FIG. 1, reference numeral 1 designates a touch panel type display/input unit acting as both a display unit for displaying the manipulation procedure/method (or instructions) for a customer, as well as the data provided by the customer. Reference numeral 2 designates a paper currency pay/receive slot for paying/receiving paper currency. Numeral 3 designates a coin pay/receive slot for paying/receiving coins. Numeral 4 designates a bankbook slot for inserting/extracting a bankbook. Numeral 5 designates a card slot for inserting/extracting a card. Numerals 6, 7 and 9 designate lamps or other illumination sources, while numeral 8 designates a sheetslot for inserting/extracting a sheet, such as a statement of payment or a statement of transfer.

Reference numeral 103 designates a read unit for reading image data from the statement which has been received through the sheetslot 8, and numeral 101 designates a recognize unit for recognizing the image data read by the read unit 103, as characters. Numeral 104 designates a storage unit for storing the data (or the statement data) on where the data are located on each type of statement and what the data are; numeral 102 designates a control unit for processing the data read by collating the statement data to the recognized image data. Numeral 106 designates a display unit for displaying the manipulation procedure/method (or the guidances) for the customer and the data inputted by the customer. Numeral 105 designates an input unit for the customer.

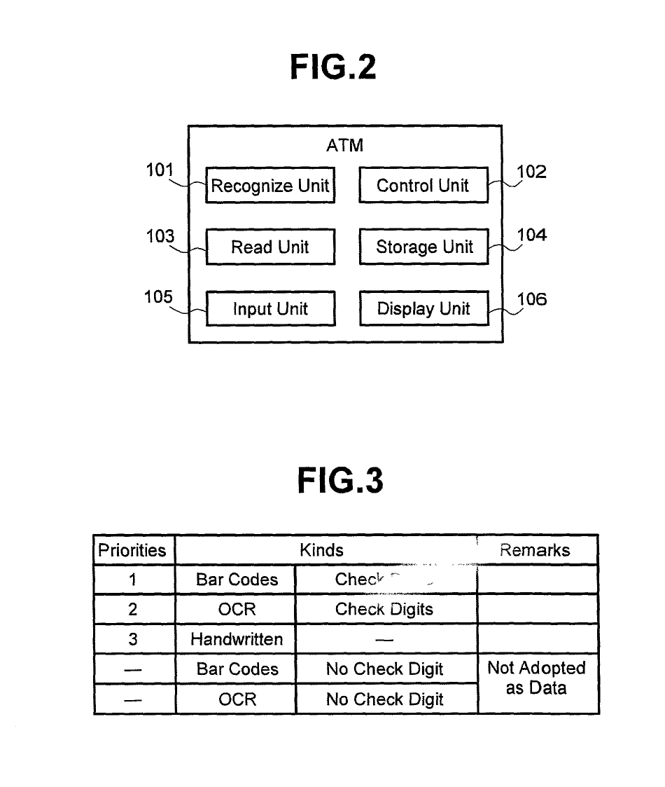

FIG. 2 is a block diagram of the ATM, in which the same components as those of FIG. 1 are designated by the common reference numerals. As shown in FIG. 2, the ATM of the present embodiment includes the read unit 103, the recognize unit 101, the storage unit 104 and the control unit 102, and further includes the display unit 106 and the input unit 105 constructing the display/input unit 1 of FIG. 1.

In a preferred embodiment of the ATM, the data (e.g., the sum data or the date data), as interpreted by a plurality of methods, are read out from the statement inserted by the customer. On the basis of these data, it is decided whether or not data provided through the ten keys by the customer are proper, and the input data to be adopted are determined by giving priorities to the data declared by the plurality of kinds of declared methods.

In the example shown in FIG. 2, the ATM apparatus is provided with the recognize unit 101 and the storage unit 104 therein. However, the construction can naturally be modified such that the recognize unit 101 and the storage unit 104 are made as external devices and connected with the ATM.

FIG. 3 is a diagram showing one example for assignment of different priorities to different types of input data. In the example of FIG. 3, these are tabulated in the higher recognition order: (Priority 1) bar codes with check digits; (Priority 2) OCR characters with check digits; and (Priority 3) handwritten characters. Bar code or OCR data without check digits, which may be erroneously recognized because of irrelevant markings on the statement, are excluded from data to be adopted.

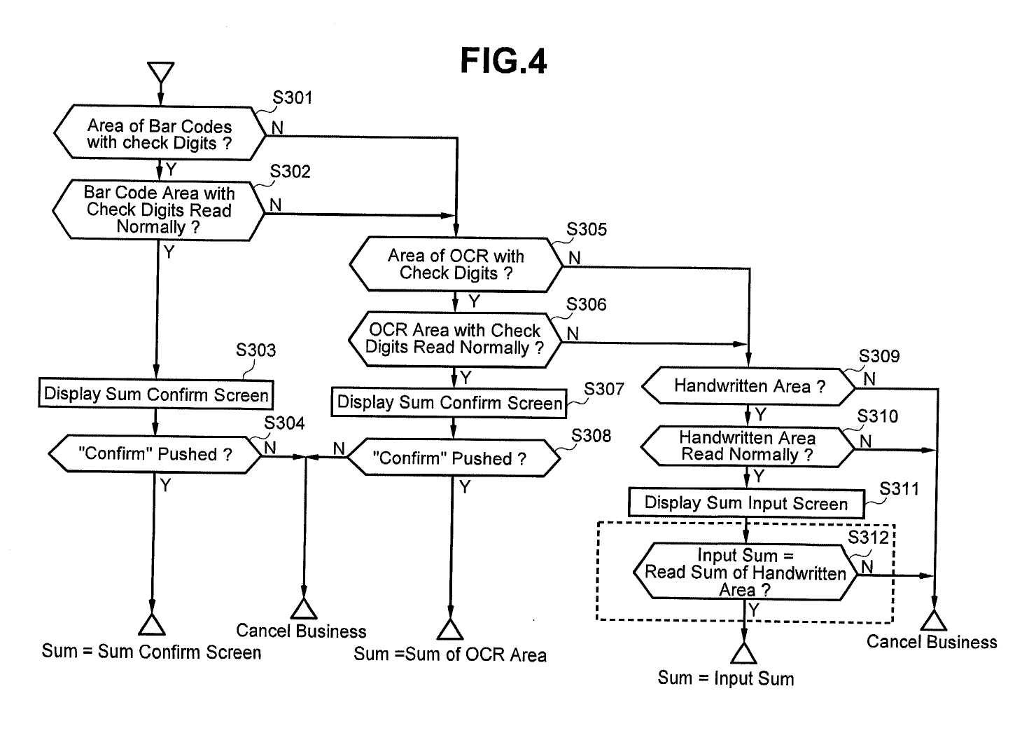

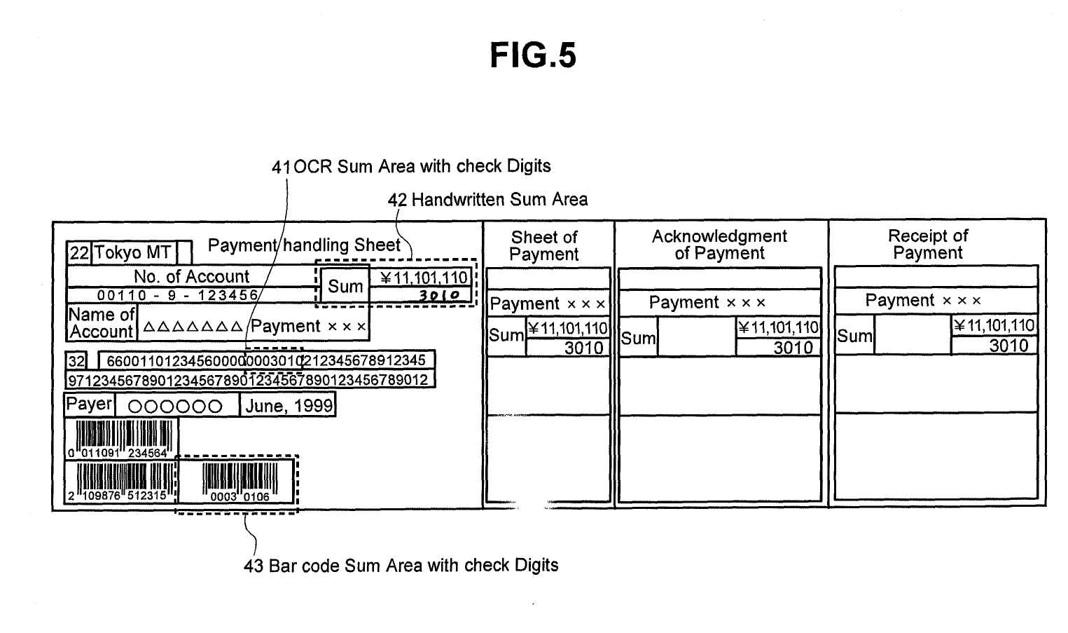

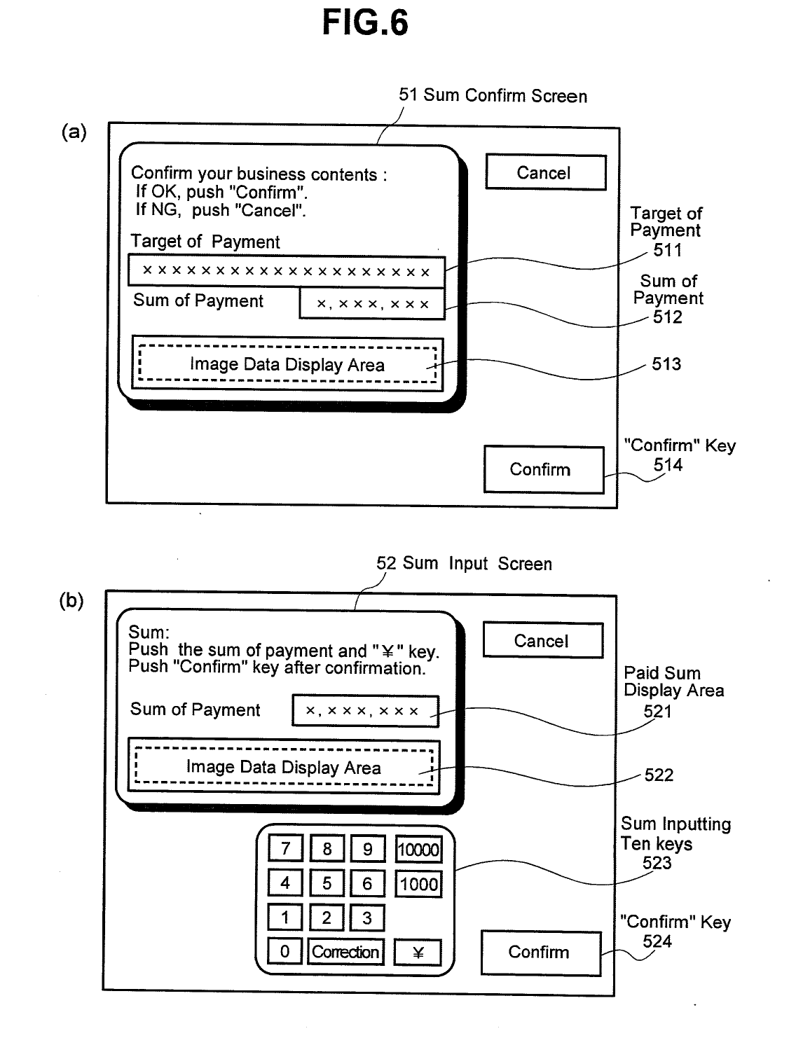

FIG. 4 is a flow chart for explaining one example of the processing procedure for determining the sum from the image data read from the statement. FIG. 5 is a diagram showing one example of the format of the statement to be employed in the present embodiment. In FIG. 5 numeral 41 designates an OCR sum area with check digits; numeral 42 designates a handwritten sum area; and numeral 43 designates a bar code sum area with check digits. FIG. 6 presents diagrams showing screens to be displayed on the display unit 106. FIG. 6(a) shows one example of a sum confirm screen, whereas FIG. 6(b) shows one example of a sum input screen.

One example of the processing procedure for determining the sum from the image data read from the statement will be described with reference to FIGS. 2, 3, 5 and 6. Storage unit 104 of the sheet handling apparatus is provided in advance with the description pattern data (as will be shortly called the “statement data”) of the various sheets to be handled.

The inserted statement (as referred to in FIG. 5) is read by the read unit 103, and the read image data are recognized as characters by the recognize unit 101. The control unit 102 determines the kind of the statement by collating the read image data to the statement data stored in advance within storage unit 104. In the statement data, there is also defined the type of data contained in each statement, but also the kind of statement.

The control unit 102 decides (at Step S301) whether or not the sum area 43 of the bar codes with the check digits is present on the inserted statement. If this answer is YES, it is then decided (at Step S302) whether or not the bar code sum area 43 with the check digits has been normally read. If the bar code sum area 43 with the check digits is present (Y: at Step S301) and has been normally read (Y: at Step S302), the read sum is displayed on a sum confirm screen 51 of the display unit 106 (at Step S303).

As shown in FIG. 6(a), a target of payment 511 and a sum of payment 512, as recognized from the read image data, are displayed in the sum confirm screen 51, and the image data of the screen displaying sum area, as defined in the statement data, are displayed as they are in an image data display area 513. If the displayed business contents are OK, a confirm key 514 is pushed (at Step S304). If the confirm key 514 is pushed in the sum confirm screen 51, there is fixed “Sum=Sum of Bar Code Area”.

If the bar code sum area 43 with the check digits is not present in the inserted statement (N: at Step S301) or if the bar code sum area 43 with the check digits, if any, is not normally read (N: at Step S302), it is then decided (at Step S305) whether or not there is the OCR sum area 41 with the check digits. If the OCR sum are 41 with the check digits is (Y: at Step S305), it is decided (at Step S306) whether or not the OCR sum area 41 with the check digits has been normally read.

If the OCR sum area 41 with the check digits is normally read (Y: at Step S306), the read sum is displayed on the sum confirm screen 51 of the display unit 106 (at Step S307). If the displayed business contents are OK, the confirm key 514 is pushed (at Step S308). If this confirm key 514 is pushed, there is fixed “Sum=Sum of OCR Area”. Here, if the confirm key 514 is not pushed at Step S304 or at Step S308, the sum cannot be determined so that the procedure is ended by canceling the business.

If neither the bar code sum area 43 with the check digits, nor the OCR sum area 41 with the check digits, is in the inserted statement (N: at Step S301, and N: at Step S305) or if none of them are normally read (N: at Step S302, and N: at Step S306), it is then decided (at Step S309) whether or not there the handwritten sum area 42. If there is the handwritten sum area 42 (Y: at Step S309), it is decided (at Step S310) whether or not the handwritten sum area 42 has been normally read.

If the handwritten sum area 42 is normally read (Y: at Step S310), a sum input screen 52, as shown in FIG. 6(b), is displayed (at Step S311) on the display unit 106. In the sum input screen 52, the sum input by the customer is displayed in the input order in a paid sum display area 521, and the image data of the screen displaying sum area defined in the statement data are displayed in an image data display area 522 (at Step S311).

When the sum is inputted and confirmed by ten keys 523 and a confirm key 524, the coincidence between the input sum from the ten keys and the sum recognized from the handwritten sum area 42 is checked (at Step S312). If coincident (Y: at Step S312), there is fixed “Sum=Input Sum” (at Step S312), and various operations including the transferring, paying and receiving operations are done by using the fixed information.

If none of the bar code sum area 43 with the check digits, the OCR sum area 41 with the check digits and the handwritten sum area 42 is in the inserted statement (N: at Step S301, N: at Step S305, and N: at Step S309), are read normally (N: at Step S302, N: at Step S306, and N: at Step S310), or if the check at Step S312 of the input sum and the sum recognized from the handwritten sum area 42 are not coincident (N: at Step S312), it is decided that the sum cannot be determined, and the procedure is ended.

If the check at Step S312 of the input sum and the sum recognized from the handwritten sum area 42 are not coincident (N: at Step S312), the procedure need not be instantly ended. Instead, as described above, the sum may be re-input. If this re-input sum and the sum recognized from the handwritten sum area 42 are again not coincident, the re-input sum may be given priority, and the transaction processed. In the embodiment as thus far described, a plurality of different kinds of formats are given the priority so that the data from the higher priority may be preferentially adopted. Where the data, as normally read and obtained from the plurality of sources, are different, however, the input data to be adopted can be determined majority decision.

As has been described in detail, according to the present invention, by using a plurality of data of different formats, it is possible to determine data reliably and to prevent errors, as might otherwise be caused by the input mistakes of the customer.

In the foregoing embodiment, the data written in the statement are recognized, including the bar code area with check digits, the OCR area with check digits and the handwritten area. Of course, while priorities have been associated with each type of information, these priorities may easily be changed.

The preceding has been a description of the preferred embodiment of the invention. It will be appreciated that deviations and modifications can be made without departing from the scope of the invention, which is defined by the appended claims.

What is claimed is:

1. A statement handling apparatus comprising:
an image reading unit for reading image data from a statement in which information is written in a plurality of areas by different methods;
a recognition unit coupled to the image reading unit for recognizing image data of the areas; and
a control unit coupled to the recognition unit for determining the information on the basis of the recognition results of the areas and for resolving differences among any different interpretations of the information determined from different areas.

2. A statement handling apparatus according to claim 1 further comprising a storage unit for storing information about at least one pattern of data of the statement; and wherein the control unit determines how to interpret data in each of the areas by using the pattern data.

3. A statement handling apparatus according to claim 2 wherein the control unit uses the image data of the areas for determining the information in accordance with predetermined priorities dependent upon the image data.

4. A statement handling apparatus according to claim 3 wherein the control unit gives a highest priority of the predetermined priorities to an area having bar codes with check digits.

5. A statement handling apparatus according to claim 1 further comprising a data input unit, and wherein the control unit determines information from at least one of the areas by using data input from the data input unit and data from the area.

6. A statement handling apparatus according to claim 5 further comprising an output unit for providing an instruction to the user, and wherein the control unit outputs, when an area being recognized has handwritten characters, an instruction to request data be input to the data input unit.

7. A statement handling apparatus according to claim 1 wherein the control unit determines, when the information of at least two of the areas is identical, that desired information is the information from the two areas.

8. A statement handing apparatus comprising:
a statement reading unit for reading a statement having a plurality of areas in which data are provided, and in response providing read data; and
a control unit for receiving the read data and deciding first and second areas in which information of one item of read data read by the statement reading unit is described; and when data in the first area are not recognized, then determining the information by using the data of the second area.

9. A statement handing apparatus according to claim 8 wherein the control unit determines the first area and the second area based upon presentation of the information in different formats.

10. A statement handing apparatus according to claim 8 wherein the statement reading unit reads the data of the statement as image data.

11. A statement handing apparatus according to claim 9 wherein, when there is an area in which information is provided as bar codes with check digits, the control unit determines that area to be the first area.

12. A statement handing apparatus according to claim 9 further comprising:
an input unit for receiving input data;
an output unit for displaying the input data; and
a control unit coupled between the input unit and the output unit, the control unit providing an interpretation of the data input when the second area includes handwritten data; and also determining, if the data from the input unit and the second area are identical, that data to be the data to be used in a subsequent process.

13. A statement handing apparatus according to claim 8 further comprising a storage unit for storing information about pattern data of the statement, and wherein the control unit determines a type of statement and information read from the first and second areas by collating the pattern data and the read data.

14. A statement handing apparatus according to claim 13 wherein the storage unit stores information about a priority to be applied when information in the first and second areas differs.

15. A method for reading a statement having a plurality of areas wherein information is described in different formats, the method comprising:
reading image data from the plurality of areas of the statement;
analyzing the image data from the plurality of areas; and
determining information for subsequent processing by using the data of at least one area.

16. A method as in claim 15 wherein the step of determining relies upon predetermined priorities for the different formats for determining the information by using data from the area recorded in a format of a highest priority.

17. A method according to claim 16 wherein:
the step of analyzing analyzes at least an area having bar codes with check digits, and
the step of determining first uses the image data of an area having bar codes with check digits.

18. A method according to claim 16 wherein, when there is one area that can be recognized in the recognized image data of the areas, the step of determine further comprises:
requesting data input;
correlating content of the data input to content of the analyzable area to thereby determine the content when the correlation results in coincidence.

19. A method according to claim 18 wherein the recognizable area includes handwritten characters.

20. A method according to claim 15 wherein the analyzing step analyzes the areas by using pattern information.

21. A method according to claim 15 further comprising after the image data of the statement is read, a step of determining the type of statement from which the image data was read by using pattern information of a plurality of statements.

22. An automated-teller machine for handling statements comprising:
a read unit for reading data from a statement; and
a control unit for acquiring first information from at least one of a plurality of areas of the statement, then determining a first area and a second area in which predetermined information is contained, by using the first information, then determining the predetermined information from the data of the first area prior to the second area and in response executing a transaction using the predetermined information.

23. An automated-teller machine according to claim 22 further comprising a storage unit for storing the first information.

24. An automated-teller machine according to claim 23 wherein the read unit reads the statement as image data.

25. An automated-teller machine according to claim 24 further comprising an input unit for receiving input data, wherein, when image data of the first area cannot be recognized, the input data is used to determine the image data.
